(19) United States
(12) Patent Application Publication
(10) Pub. No.: US 2016/0247323 A1
(43) Pub. Date: Aug. 25, 2016

(54) HEAD MOUNTED DISPLAY, INFORMATION PROCESSING SYSTEM AND INFORMATION PROCESSING METHOD

(71) Applicant: Takeshi SHIMAZAKI, Kanagawa (JP)

(72) Inventor: Takeshi SHIMAZAKI, Kanagawa (JP)

(73) Assignee: Ricoh Company, Ltd., Ohta-ku (JP)

(21) Appl. No.: 15/000,344

(22) Filed: Jan. 19, 2016

(30) Foreign Application Priority Data
Feb. 24, 2015 (JP) 2015-034483

(51) Int. Cl. G06T 19/00; G06K 9/00; G02B 27/01

(52) U.S. Cl. CPC G06T 19/006; G02B 27/0172; G06K 9/00409; G06K 9/00422; G02B 2027/0178; G02B 2027/0138; G02B 2027/014

(57) ABSTRACT

A transmissive head mounted display includes an imaging device to acquire an image of a real space, the real space including at least a medium to which a user can physically add handwriting; a display to display a virtual image of electronic data to the user so as to be superimposed on the medium in the real space using the acquired image of the real space; and processing circuitry configured to acquire an image of the real space including at least the medium having the handwringing of the user added, extract handwritten information from the image of the real space including at least the medium having the handwriting of the user added, and superimpose the extracted handwritten information on an image of the electronic data.

### CROSS-REFERENCE TO RELATED APPLICATIONS

This patent application is based on and claims priority pursuant to 35 U.S.C. §119(a) to Japanese Patent Application No. 2015-034483, filed on Feb. 24, 2015, in the Japan Patent Office, the entire disclosure of which is hereby incorporated by reference herein.

### BACKGROUND

1. Technical Field

The present invention relates to a head mounted display, an information processing system, and an information processing method.

2. Description of the Related Art

A head mounted display (HMD) is known, which generates a virtual image of electronic data in a user's field of view. Such HMD is also called as an eye glass-type wearable device. HMDs are categorized into a non-transmissive type HMD and transmissive type (see-through type) HMD. The non-transmissive type HMD blocks a view of a user, who is wearing the HMD, whereas the transmissive type (see-through type) HMD does not block the user's view, who is wearing the HMD. The transmissive type HMD allows a user to visually recognize a real space simultaneously with the virtual image of electronic data.

### SUMMARY

In an aspect of the present invention, a transmissive head mounted display includes an imaging device to acquire an image of a real space, the real space including at least a medium to which a user can physically add handwriting; a display to display a virtual image of electronic data to the user so as to be superimposed on the medium in the real space using the acquired image of the real space; and processing circuitry configured to acquire an image of the real space including at least the medium having the handwringing of the user added, extract handwritten information from the image of the real space including at least the medium having the handwriting of the user added, and superimpose the extracted handwritten information on an image of the electronic data.

In another aspect of the present invention, an information processing system includes the above-described head mounted display and an electronic device.

In still another aspect of the present invention, an information processing method performed by a transmissive head mounted display, includes acquiring an image of a real space, the real space including at least a medium to which a user can physically add handwriting; displaying a virtual image of electronic data to the user so as to be superimposed on the medium in the real space using the acquired image of the real space; acquiring an image of the real space including at least the medium having the handwringing of the user added; extracting handwritten information from the image of the real space including at least the medium having the handwriting of the user added; and superimposing the extracted handwritten information on an image of the electronic data.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram of a configuration of an information processing system according to an exemplary embodiment of the present invention;

FIG. 2 is a block diagram illustrating a hardware configuration of an image forming apparatus, which is an example of an electronic device in the information processing system of FIG. 1;

FIG. 3 is a schematic diagram illustrating a software layer structure of the electronic device in FIG. 2;

FIG. 4 is a diagram illustrating a hardware configuration of a terminal in the information processing system of FIG. 1;

FIG. 5 is a diagram illustrating software configuration of the electronic device and the terminal in the information processing system of FIG. 1;

FIGS. 6A to 6F are diagrams illustrating device identification images of an electronic device in an information processing system according to an exemplary embodiment of the present invention;

FIG. 7 is a sequence diagram illustrating operation performed by the information processing system of FIG. 1, from acquiring a device identification image and connection information, to requesting for executing functions, according to an exemplary embodiment of the present invention;

FIG. 8 is a schematic diagram illustrating a configuration of an information processing system according to an exemplary embodiment of the present invention;

FIGS. 9A to 9F are diagrams for explaining an operation for editing electronic data, performed by the information processing system of FIG. 8;

FIG. 10 is a diagram illustrating a software configuration of a terminal in the information processing system of FIG. 8;

FIG. 11 is a flowchart illustrating a procedure of an AR display and addition of handwriting in the information processing system of FIG. 8, according to the exemplary embodiment of the present invention; and

FIGS. 12A to 12F are diagrams for explaining the procedure illustrated in FIG. 11.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

<Information Processing System>

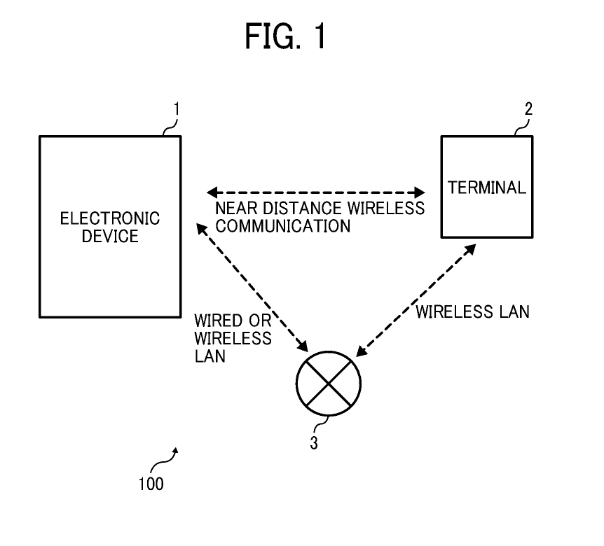

FIG. 1 is a schematic diagram of the configuration of an information processing system 100 according to an exemplary embodiment of the present invention. The information processing system 100 includes an electronic device 1 and a terminal 2, which are connected with each other via a near-distance wireless communication network and a network 3.

The electronic device 1 may be an image forming apparatus such as a printer, which receives a printing job in response to a request from the terminal 2 and prints an image based on print target data. Alternatively, the image forming apparatus may be a multifunction peripheral (MFP) having multiple functions such as a copier function, a scanner function, and a facsimile function in addition to a printer function.

Examples of the electronic device 1 may also include office equipment such as an electronic whiteboard and a projector, audio visual equipment such as a television receiver, a display and an audio device, and household electric appliances such as a washing machine, a dryer and a refrigerator.

The terminal 2 functions as a remote controller that connects with the electronic device 1 and instructs the electronic device 1 to perform various functions. In a case where the electronic device 1 is implemented by the image forming apparatus, the terminal 2 is installed with application software that allows the terminal 2 to instruct the electronic device 1 to print an image based on the print target data. The terminal 2 generates a printing job including the print target data and transmits the printing job to the image forming apparatus or a print server. The terminal 2 further includes a near distance wireless communication device such as a near field communication (NFC) chip.

Furthermore, the terminal 2 is provided with an imaging device 42. The terminal 2 may be an eye glass-type wearable device or a head mounted display, which is a transmissive type device having an augmented reality (AR) displaying function and an imaging function. Wearing the terminal 2 as described above, a user is able to visually recognize a real space in the user's front view simultaneously with a virtual image of electronic data in such a manner that the virtual image of the electronic data is overlapped with the real space. The terminal 2 may receive the electronic data from an external apparatus such as the electronic device 1 or may store the electronic data acquired in advance in its internal memory. The terminal 2 also allows the user to take an image of a region at least in front of the user. Examples of the terminal 2 may also include a mobile phone, a laptop personal computer (PC), and smart devices such as a smartphone and a tablet each provided with a camera.

In this exemplary embodiment, explanation will be made of a printing system as an example of the information processing system. However, various systems, such as output/display system, which executes a predetermined function of the electronic device 1 in response to a request from the terminal 2 may be applied as the information processing system.

<Hardware Configuration of Image Forming Apparatus>

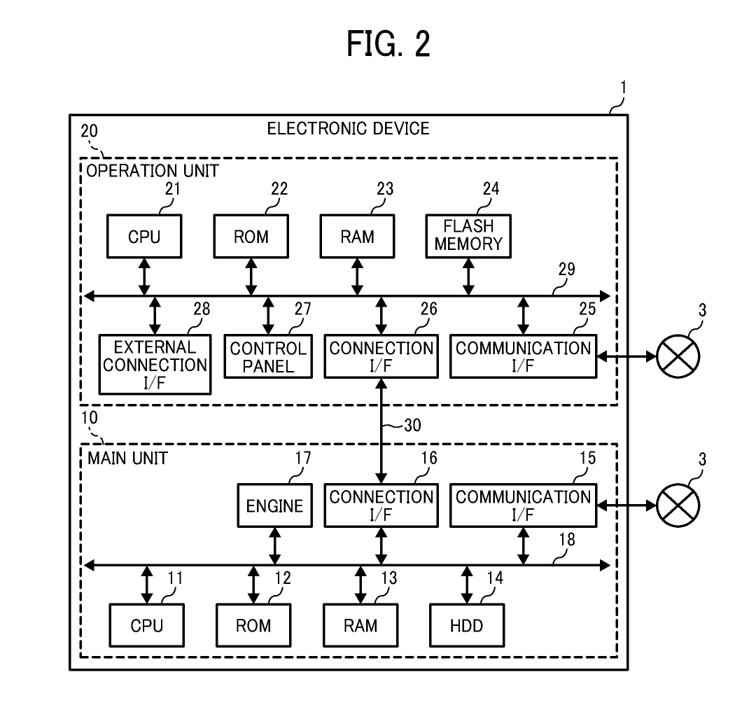

FIG. 2 is a block diagram illustrating a hardware configuration of the image forming apparatus, which is an example of the electronic device 1 illustrated in FIG. 1.

As illustrated in FIG. 2, the electronic device (e.g., image forming apparatus) 1 includes a main unit 10 and an operation unit 20. The main unit 10 is capable of implementing various functions such as a copier function, a scanner function, a facsimile function and a printer function. The operation unit 20 receives the user's operation. Herein, the “receiving the user's operation” is a concept including receiving information that is input in response to the user's operation. The information to be received may include a signal indicating a coordinate value on a screen.

The main unit 10 and the operation unit 20 are communicably connected with each other via a dedicated communication path 30. The communication path 30 may be in compliance with a universal serial bus (USB) standard. However, any arbitrary standard, regardless of wired or wireless, may be used as the communication path 30.

The main unit 10 operates in response to an operation received by the operation unit 20. The main unit 10 is also capable of communicating with an external apparatus such as a client personal computer (PC) and operating in response to an instruction received from the external apparatus.

First, the hardware configuration of the main unit 10 will be described hereinafter. The main unit 10 includes a central processing unit (CPU) 11, a read only memory (ROM) 12, a random access memory (RAM) 13, a hard disk drive (HDD) 14, and a communication interface (I/F) 15, a connection I/F 16, and an engine 17, which are connected with one another via a system bus 18.

The CPU 11 controls entire operation of the main unit 10. The CPU 11 controls the entire operation of the main unit 10 by executing programs stored in the ROM 12 or the HDD 14, etc., using the RAM 13 as a work area, to implement various functions such as a copier function, a scanner function, a facsimile function and a printer function as described above. The communication I/F 15 is an interface for connecting the main unit 10 with the network 3. The connection I/F 16 is an interface for allowing the main unit 10 to communicate with the operation unit 20 via the communication path 30.

The engine 17 is a hardware for performing general information processing for implementing the copier function, the scanner function, the facsimile function or the printer function. The engine 17 includes, for example, a scanner (image reading unit) that scans and reads an image on a document, a plotter (image forming unit) that performs printing on a sheet such as paper, and a facsimile unit that performs facsimile communication. The engine 17 may further include optional equipment such as a finisher that sorts the printed sheets, and an automatic document feeder (ADF) that automatically feeds documents to be scanned.

Next, the hardware configuration of the operation unit 20 will be described hereinafter. The operation unit 20 includes a CPU 21, a ROM 22, a RAM 23, a flash memory 24, a communication I/F 25, a connection I/F 26, a control panel 27, and an external connection I/F 28, which are connected with one another via a system bus 29.

The CPU 21 controls entire operation of the operation unit 20. The CPU 21 controls the entire operation of the operation unit 20 by executing programs stored in the ROM 22 or the flash memory 24, etc., using the RAM 23 as a work area, and to implement various functions as described later, such as displaying information or images in response to the input from the user. The communication I/F 25 is an interface for connecting the operation unit 20 with the network 3. The connection I/F 26 is an interface for allowing the operation unit 20 to communicate with the main unit 10 via the communication path 30.

The control panel 27 receives various inputs in response to the user's operations and displays various information such as information corresponding to the received operation, information indicating the operational status of the image forming apparatus, information indicating the setting status, etc. In this exemplary embodiment, the control panel 27 is implemented by a liquid crystal display (LCD) having a touch panel function, however, such a LCD is exemplary. For example, the control panel 27 may be implemented by an organic electro luminescence (EL) display having a touch panel function. Instead of or in addition to the control panel 27, an operation unit such as hardware keys and/or a display unit such as an indicator lump may be provided.

<Layer Structure of Software of Image Forming Apparatus>

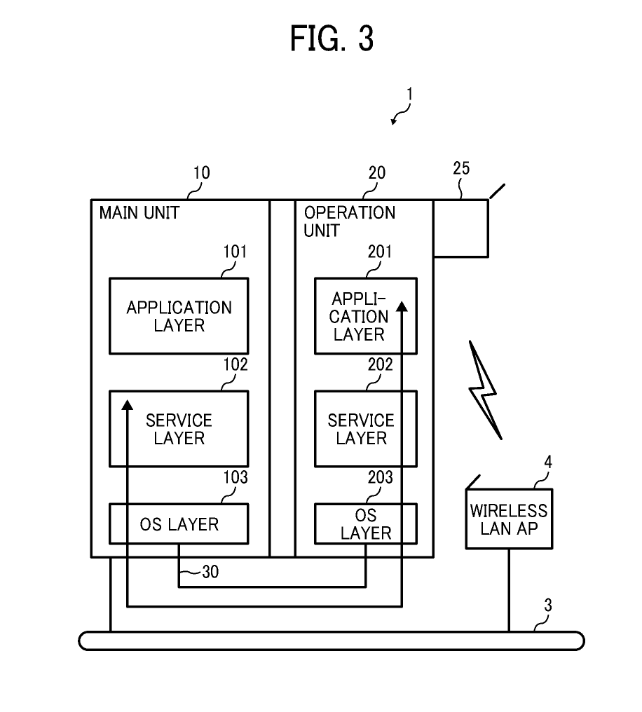

Next, a software configuration of the image forming apparatus 1, which is an example of the electronic device 1, will be described hereinafter. FIG. 3 is a schematic diagram illustrating a software layer structure of the electronic device 1 (image forming apparatus) illustrated in FIG. 2.

As illuustrated in FIG. 3, the main unit 10 includes an application layer 101, a service layer 102 and an operating system (OS) layer 103. The entities of the application layer 101, the service layer 102 and the operating system are various types of software stored in the ROM 12 or the HDD 14, etc. The CPU 11 executes the software as above to provide various functions.

The software for the application layer 101 is an application software that causes hardware resources to operate to provide various functions. The terms “application software” may be referred to as an “application” hereinafter. Examples of the applications may include a copy application that provides a copier function, a scanner application that provides a scanner function, a facsimile application that provides a facsimile function, and a printer application that provides a printer function.

The software for the service layer 102, which is provided between the application layer 101 and the OS layer 103, provides the application with an interface for using the hardware resources of the main unit 10. More specifically, the software for the service layer 102 provides the functions of receiving the operation requests to the hardware resources and mediating the operation requests. Examples of the operation requests that the service layer 102 receives may include a request for scanning by the scanner and a request for printing by the plotter.

The interface function by the service layer 102 may be also provided to an application layer 201 of the operation unit 20 as well as the application layer 101 of the main unit 10. In other words, the application layer 201 (application) of the operation unit 20 is capable of implementing functions utilizing the hardware resources (e.g., engine 17) of the main unit 10 via the interface function of the service layer 102.

The software for the OS layer 103 is basic software (operating system) for providing basic functions of controlling the hardware of the main unit 10. The software for the service layer 102 converts each of the requests received from various applications for using the hardware resources, to a command that is interpretable by the OS layer 103. The software for the service layer 102 passes the command to the OS layer 103. The software for the OS layer executes the command to allow the hardware resources to operate in accordance with the request by the application.

The operation unit 20 similarly includes the application layer 201, a service layer 202 and an OS layer 203. The application layer 201, the service layer 202 and the OS layer 203 of the operation unit 20 has a similar layer structure as the main unit 10.

However, the functions provided by the application of the application layer 201 and the operation requests to be received by the service layer 202 are different from those of the main unit 10. The application of the application layer 201 may be software for causing the hardware resources of the operation unit 20 to operate so as to provide predetermined functions. In the meantime, the application of the application layer 201 is mainly software for providing the user interface (UI) function for operating or displaying functions that the main unit 10 includes, such as a copier function, a scanner function, a facsimile function and a printer function. The communication I/F 25 is software for connecting with the network 3 via a wireless local area network (LAN) access point (AP).

In this exemplary embodiment, the software for the OS layer 103 that the main unit 10 includes and the software for the OS layer 203 that the operation unit 20 includes are different from each other in order to maintain the independency of functions. In other words, the main unit 10 and the operation unit 20 operate independently with each other on separate operation systems. For example, Linux (registered trademark) may be used as the software for the OS layer 103 of the main unit 10, whereas Android (registered trademark) may be used as the software for the OS layer 203 of the operation unit 20.

As described above, in the electronic device 1 according to this exemplary embodiment, the main unit 10 and the operation unit 20 respectively operate on separate operating systems. Accordingly, communications between the main unit 10 and the operation unit 20 are performed as communications between separate apparatuses instead of interprocess communication within a common apparatus. Examples of the communications between the main unit 10 and the operation unit 20 may include command communication, which is an operation of transmitting the information (e.g., instruction contents) received by the operation unit 20 to the main unit 10. Examples of the communications between the main unit 10 and the operation unit 20 may further include an operation by the main unit 10 of notifying the operation unit 20 of an event. In this exemplary embodiment, the operation unit 20 communicates commands to the main unit 10 to use the functions of the main unit 10. Examples of the events notified from the main unit 10 to the operation unit 20 may include the execution status of operation in the main unit 10 and contents set in the main unit 10.

In this exemplary embodiment, power is supplied from the main unit 10 to the operation unit 20 via the communication path 30. Accordingly, the power control of the operation unit 20 may be performed separately (independently) from the power control of the main unit 10.

<Hardware Configuration of Terminal>

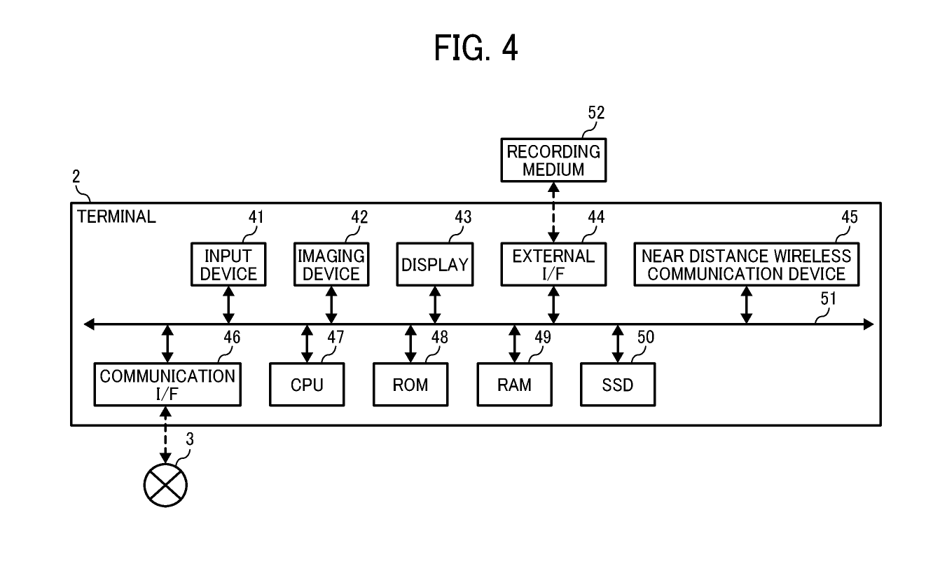

FIG. 4 is a diagram illustrating a hardware configuration of the terminal 2 illustrated in FIG. 2.

As illustrated in FIG. 4, the terminal 2 includes, an input device 41, the imaging device 42, a display 43, an external I/F 44, a near distance wireless communication device 45, a communication I/F 46, a CPU 47, a ROM 48, a RAM 49, and a solid state drive (SSD) 50, which are connected with each other via a bus 51.

The input device 41 allows a user to input an instruction. The terminal 2 includes at least one of devices including a touch input device, a key input device, a voice input device and a line-of-sight input device.

The touch input device detects a part of the terminal 2 being touched by the user, and converts the detected touch to an input signal. The key input device detects pressing of a key on the terminal 2, and outputs an input signal based on detection.

The voice input device detects a user's voice collected with a microphone that the terminal 2 includes, and recognizes the input contents. For example, when the user says, “take a photo”, to the microphone, the voice input device recognizes that a photographing function is to be executed, and activates the imaging device 42 to execute photographing. The voices to be input and the functions to be executed are stored in a table in a memory (ROM 48 or SSD 50).

The line-of-sight input device detects the movement of the user's eyes. Examples of the line-of-sight input device may include a camera that the terminal 2 (eye-glass-type wearable device) includes. The camera detects the direction and movement of the user's line of sight. Upon detecting that the user has been looking at a certain place for a predetermined time, the camera selects the user interface displayed in a direction of the certain place on the display 43. The terminal 2 may further include a keyboard or a mouse.

The imaging device 42 is a camera built in the terminal 2. In a case where the terminal 2 is implemented by the eye-glass-type wearable device, the imaging device 42 (e.g., camera) is mounted on a frame of the eye glasses to allow the camera to take an image of a region in front of the user.

Examples of the display 43 may include a LCD and a glass part of the eye-glass-type wearable device, which glass part serves as a display. The display 43 displays electronic data including electronic documents, images or messages, to the user in such a manner that the user can visually recognize the electronic data. The transmittance of the LCD is controlled so as to make it possible for the user to see objects in the real space within the user's view simultaneously with the electronic data.

The external I/F 44 is an interface with a recording medium 52. The terminal 2 reads or writes data from or to the recording medium 52 via the external I/F 44. Examples of the recording medium 52 may include a SD card, a USB memory, and a flexible disk.

Examples of the near distance wireless communication apparatus 45 includes the NFC chip. The near distance wireless communication apparatus 45 allows the terminal 2 to communicate data with the electronic device 1.

The communication I/F 46 is an interface for connecting the terminal 2 to a portable phone network or the Internet. The terminal 2 can communicate data with an external apparatus via the communication I/F 46.

The CPU 47 loads programs or data into the RAM 49 from the storage such as the ROM 48 and the SSD 50 and executes processing so as to control the entire operation of the terminal 2 and to implement the functions of the terminal 2. The ROM 48 is a nonvolatile semiconductor memory, which holds programs or data even after the terminal 2 is turned off as the power is not supplied. The ROM 48 stores the basic input output system (BIOS), which is executed when the terminal is started up, the OS setting, the network setting and the like. The RAM 49 is a volatile semiconductor memory, which temporarily holds programs or data.

The SSD 50 is a nonvolatile storage that stores programs or data therein. Examples of programs or data stored in the SSD 50 may include an OS for controlling the entire operation of the terminal 2 or application software providing various functions on the OS. The SSD 50 manages the programs or data stored therein by a predetermined file system or a predetermined database. A HDD may be provided instead of the SSD 50.

<Software Configuration of Electronic Device and Terminal>

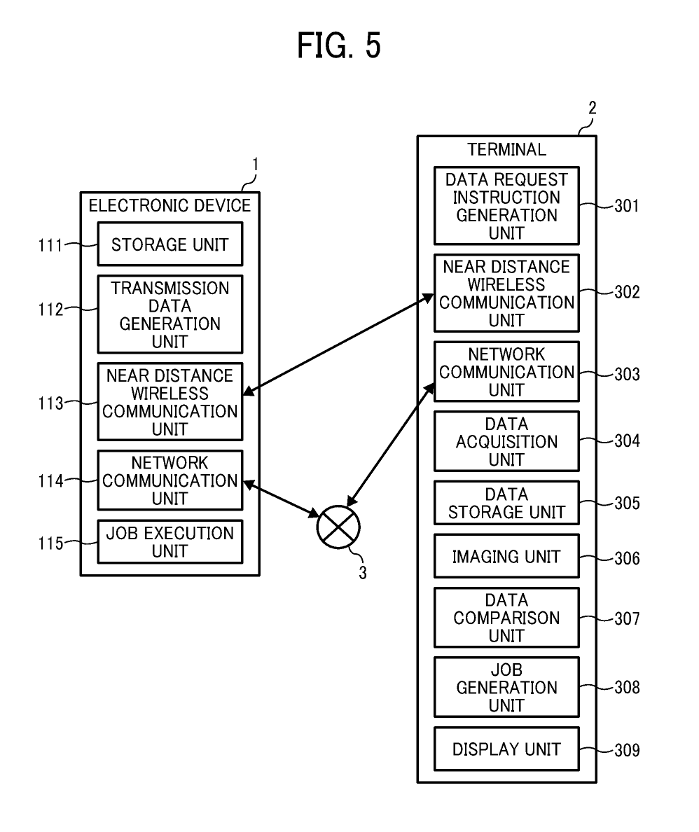

FIG. 5 is a diagram illustrating the software configuration of the electronic device 1 and the terminal illustrated in FIG. 1.

As illustrated in FIG. 5, the electronic device 1 includes a storage unit 111, a transmission data generation unit 112, a near distance wireless communication unit 113, a network communication unit 114, and a job execution unit 115.

The storage unit 111 stores a device identification image, connection information, and the like. The device identification image and the connection information will be described later. The transmission data generation unit 112 receives, from the terminal 2, an instruction for requesting the transmission of the device identification image and the connection information. In response to receiving the instruction from the terminal 2, the transmission data generation unit 112 takes out data from the storage unit 111 to generate the transmission data.

The near distance wireless communication unit 113 performs the near distance wireless communication with the terminal 2 by the near distance wireless communication device. The network communication unit 114 transmits or receives various data to or from the terminal 2 or the print server by the communication I/Fs 15 and 25.

In response to receiving a data requesting instruction from the near distance wireless communication unit 113, the network communication unit 114 transmits the transmission data (e.g., the device identification image and the connection information) to a network communication unit 303 of the terminal 2. Alternatively, the transmission data may be transmitted to the near distance wireless communication unit 113.

The job execution unit 115 receives the printing job and executes the received printing job by the CPU 11. The job execution unit 115 includes a printer function unit, a scanner function unit, a copier function unit, and a facsimile function unit. The printer function unit prints an image based on the target data by an image forming engine such as a printer, the target data being included in the printing job executed by the job execution unit 115. The scanner function unit generates image data (electronic data) from the scanned document. The copier function unit makes a copy of the scanned document. The facsimile function unit faxes an image of the scanned document or the electronic data via a telephone line.

The terminal 2 includes a data request instruction generation unit 301, a near distance wireless communication unit 302, a network communication unit 303, a data acquisition unit 304, a data storage unit 305, an imaging unit 306, a data comparison unit 307, a job generation unit 308, and a display unit 309.

The data request instruction generation unit 301 generates a request for transmitting data such as the device identification image and the connection information that the storage unit 111 of the electronic device (e.g., image forming apparatus) 1 stores. The near distance wireless communication unit 302 is implemented by the near distance wireless communication device 45, and performs near distance wireless communication with the electronic device 1. The network communication unit 303 is implemented by the communication I/F 46, and transmits or receives data including the printing job via the network 3.

The data acquisition unit 304 receives data including the device identification image and the connection information transmitted from the electronic device 1. The data storage unit 305 stores data including the device identification image and the connection information.

The imaging unit 306 captures an image by a camera (imaging device 42) and transmits the captured image to the data comparison unit 307. The data comparison unit 307 compares the image captured by the camera with the device identification image. In a case where the feature of the image captured by the camera matches the feature of the device identification image, the data comparison unit 307 instructs the destination for connection to establish connection.

In response to a user's selection of the print target data with application software such as a browser application, a document viewer application and a printing application, the job generation unit 308 generates a printing job for printing the selected print target data (the CPU 47 executes this processing). The display unit 309 displays the electronic data, which the terminal 2 displays with an application software for example, as an image that the user is able to visually recognize on the display 43.

The terminal 2 or the data comparison unit 307 may include a timer or a counter. The connection with a connection destination may be instructed when the moving image captured by the camera matches the device identification image for a certain period of time based upon the detection by timer. Alternatively, the connection with a connection destination may be instructed when a certain numbers of images captured by the camera match the device identification image. Further, the terminal 2 may store, for each one of a plurality of electronic devices (e.g., plural image forming apparatus), the device identification image in association with the connection information.

<Device Identification Image of Electronic Device>

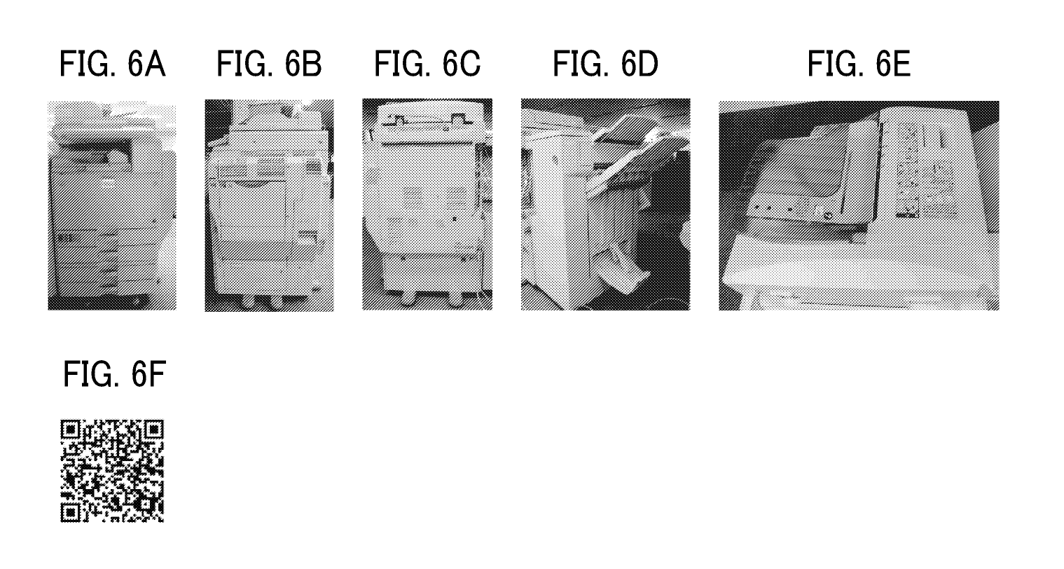

FIGS. 6A to 6F are diagrams illustrating the device identification images of the electronic device 1.

The device identification image is held by the storage unit 111 of the electronic device 1. Any one of the storage unit 111 of the main unit 10 and the data storage unit 305 of the operation unit 20 may store the device identification image. By causing the data storage unit 305 of the operation unit 20 to store the device identification information and causing the communication I/F 25 (FIG. 2) of the operation unit 20 to transmit, the setting operation of the terminal 2 and the electronic device 1 can be performed without interrupting other image forming operations of the main unit 10.

The device identification image has two examples, e.g., first and second examples. One example (first example) of the device identification image is an image of appearance of the main unit 10 of the electronic device 1, such as photo images that are obtained by photographing the electronic device 1 from plural directions. The data of the photo images are stored in the storage unit in manufacturing the electronic device 1. Otherwise, the data of the photo images may be taken by the user with the terminal 2 and transferred to the electronic device 1.

FIGS. 6A to 6E respectively illustrate the front, back, right side, left side and upper faces of the main unit 10 of the electronic device 1. Because the electronic device 1 is taken to have photos of the front, back, right side, left side and upper faces of the main unit 10 as described above, it is possible to recognize the electronic device 1 with a photo of the electronic device 1 taken from any one of the directions.

The other example (second example) of the device identification image is an image of a QR code (registered trademark) or a color code having the information including the name, the model number and the like of the electronic device 1 embedded therein. A sheet of paper or seal having the image of the code(s) thereon is stuck to the housing of the electronic device 1 so that these code(s) can be photographed by the camera of the terminal 2. FIG. 6F illustrates an image of the QR code (registered trademark).

Examples of the connection information include an IP address of the electronic device 1, a service set identifier (SSID), and password, which are used for connecting the electronic device 1 to the network. In a case where the device identification image is that of the second example, the connection information may be embedded in the code. The connection information relates to either the communication I/F 15 of the main unit 10 or the communication I/F 25 of the operation unit 20.

In a case where the device identification image is that of the first example, the storage unit 111 stores the device identification image in association with the connection information of the electronic device 1. In response to the change of the IP address or the SSID, the electronic device 1 automatically updates the connection information to reflect the change, such that the device identification image is associated with the updated connection information. Further, in response to the change of the IP address or the SSID, the new IP address or SSID is sent to the terminal 2 from the electronic device 1 (or a device managing server connected to the electronic device 1 via the network 3). The electronic device 1 or the device managing server holds the destination information (e.g., address) of the terminal 2 to which the electronic apparatus 1 transmits the device identification image.

In a case where the device identification image is that of the second example, the electronic device 1 itself may generate the code(s) using the name, the model number or the connection information (which is most recently updated) of the electronic device 1. In response to an instruction from the terminal 2 requesting the electronic device 1 for the device identification image and connection information, the electronic device 1 transmits the device identification image and the connection information to the terminal 2.

<Procedure of Connection between Terminal and Electronic Device>

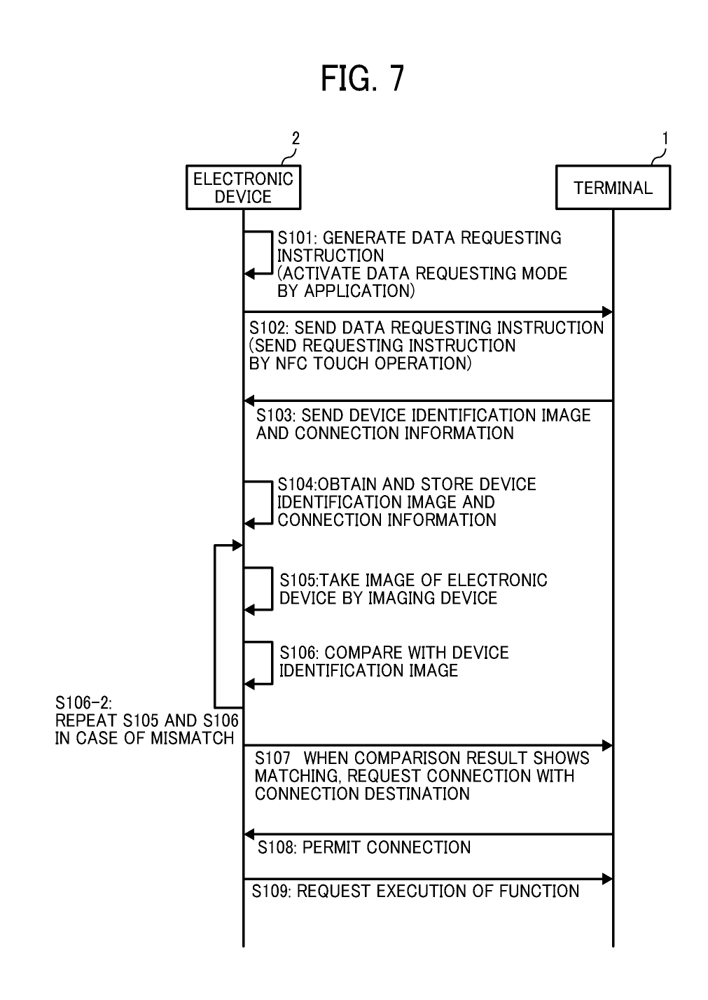

FIG. 7 is a sequence diagram illustrating operation, performed by the system 100, from acquiring the device identification image and the connection information from the electronic device 1 by the terminal 2, to requesting for executing the functions, according to an embodiment of the present invention.

First, the data request instruction generation unit 301 of the terminal 2 generates an instruction requesting the electronic device 1 for the device identification image and the connection information (S101). Specifically, a data requesting mode of a remote control application (print application) is activated by the touch operation or voice or line-of-sight detection from the input device 41 of the terminal 2. In response to the activation of the data requesting mode, the data request instruction generation unit 301 generates the instruction.

Next, when the terminal 2 connects to the electronic device 1 while keeping the data requesting mode activated, the data requesting instruction is sent to the electronic device 1 via the near distance wireless communication unit 302 (S102). Specifically, in response to bringing the terminal 2 into close contact with or near the near distance wireless communication unit 113 of the electronic apparatus 1, the data requesting instruction is sent to the electronic device 1.

Then, the electronic device 1 sends the device identification image and the connection information stored in the storage unit 111 of the electronic device 1 from the network communication unit 114 to the network communication unit 303 of the terminal 2 (S103). Then, the terminal 2 stores the device identification image and the connection information in the data storage unit 305 (S104).

At S101 to S104 described so far, the device identification image and the connection information of the electronic device 1 is acquired by the terminal 2, and a pairing operation is performed by which the electronic device 1 becomes identifiable to the terminal 2.

Then, the terminal 2 images the electronic device 1 by the imaging device 42 (S105). For example, in response to a remote control instruction such as a printing job instruction from the input device 41, the imaging device 42 is activated. Alternatively, the imaging device 42 may be kept activated all the time so as to keep imaging.

Then, the terminal 2 compares the image captured by the imaging device 42 with the stored device identification image (S106). When the comparison result shows the mismatch between the captured image and the device identification image (S106-2), S105 and S106 are repeated. When the comparison result shows that the captured image matches the device identification image, the connection information is set to the destination for connection of the network communication unit 303, and the connection with the set connection destination is requested (S107). Then, in response to transmission of connection permission from the electronic device 1 to the terminal 2 (S108), the terminal 2 sends a function execution request to the electronic device 1 (S109).

Thus, the user of the terminal 2 only has to make the electronic device 1 be imaged by the camera (e.g., the user only has to look in the direction of the electronic device) to execute S105 to S107 to execute a desired function.

As described in detail so far, the information processing system 100 according to the exemplary embodiment of the present invention has the following features (1) and (2)

(1) The terminal 2 controls the electronic device 1 to transmit the device identification image and the connection information (e.g., IP address, SSID) and acquire the transmitted image and information in response to the predetermined operation to the input device 41. Accordingly, with a simple operation of operating the input device 41, the paring is performed by which the electronic device 1 becomes identifiable to the terminal 2

(2) The device identification image, which is acquired in advance by the terminal 2, is compared with the image of the object in front of user captured by the imaging device 42 of the terminal 2, which object correspond to the object that the user is looking at. When the comparison result shows that the device identification image matches the captured image, the connection between the electronic device 1 and the terminal 2 is performed using the connection information corresponding to the device identification image obtained by the paring. Accordingly, with a simple operation of imaging the electronic device 1 by the terminal 2, the terminal 2 and the electronic device 1 are connected with each other via the near distance wireless communication.

With the information processing system 100 according to this exemplary embodiment of the present invention, when connecting a portable terminal to an information processing apparatus such as an image forming apparatus via a near distance wireless communication, a user does not have to bring the portable terminal close to the information processing apparatus.

<Information Processing System>

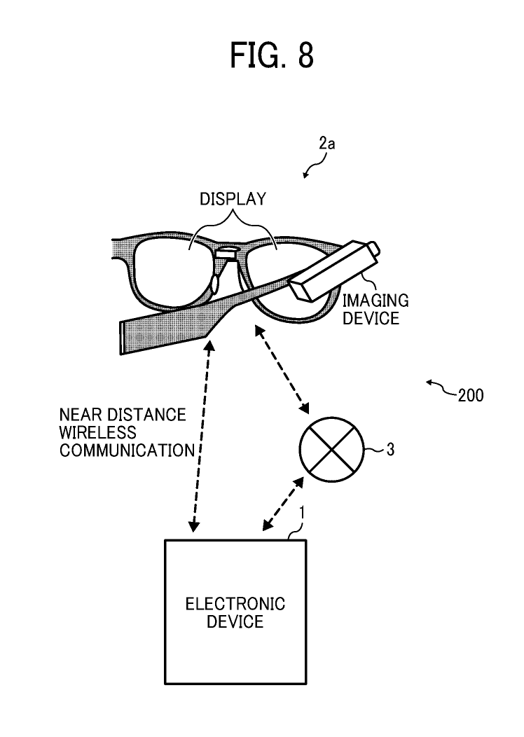

FIG. 8 is a schematic diagram illustrating the configuration of an information processing system 200 according to an exemplary embodiment of the present invention. In FIG. 8, the identical or corresponding parts as those of the processing system 100 of FIG. 1 are denoted by the same reference numbers of FIG. 1. Explanation will be omitted of the configurations and function of these parts for simplicity.

The information processing system 200 includes the electronic device 1 and a terminal 2a, which are connected with each other via the near-distance wireless communication network and the network 3.

The terminal 2a is a transmissive eye glass-type wearable device having an AR displaying function, which has a same configuration as where the eye glass-type wearable device is used as the terminal 2. For instance, the terminal 2a has the imaging device 42 of FIG. 4. In other words, the terminal 2a has the function of taking an image of a real space at least in front of a user, who is wearing the device, and the function of allowing the user to look at the real space and electronic data simultaneously by displaying a virtual image of the electronic data in an overlapping manner within a user's view. As described above, the terminal 2a may be implemented by a smart device such as a smartphone or a tablet, or a transparent display.

Examples of the electronic device 1 include an image forming apparatus, a smart device, and a server, each of which is capable of being connected to the network 3 by wired or wireless communication. Alternatively, the electronic device 1 may be other devices that are capable of transmitting electronic data to the terminal 2a. Example of such devices include office equipment such as an electronic whiteboard and a projector, audio visual equipment such as a television receiver, a display and an audio device, and household electric appliances such as a washing machine, a dryer and a refrigerator.

<Operation of Editing Electronic Data>

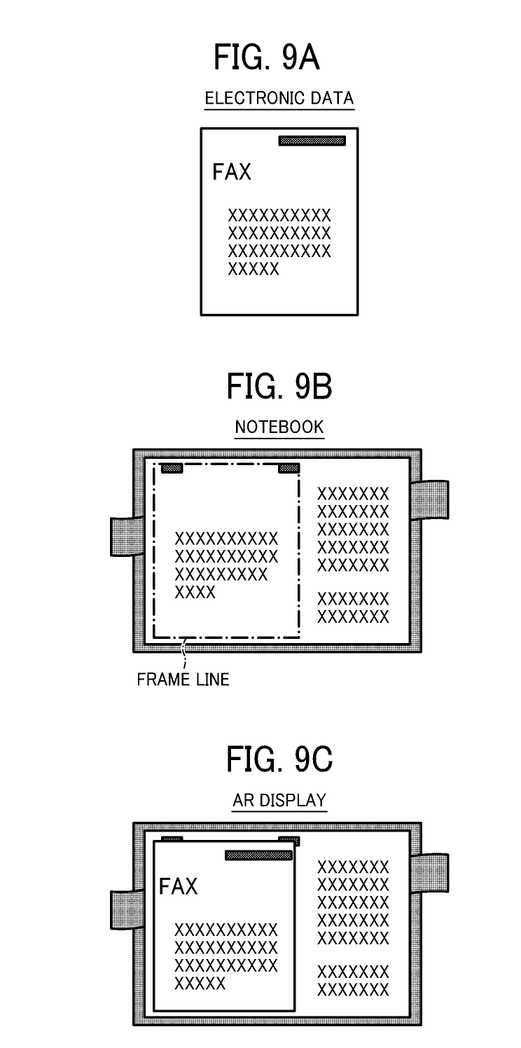

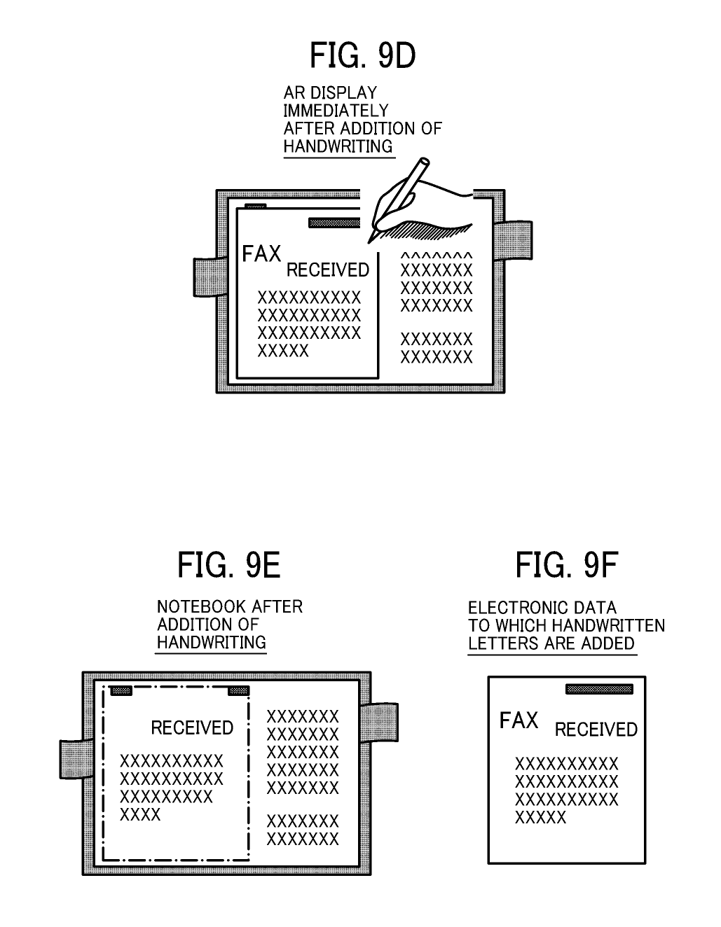

FIGS. 9A to 9F are diagrams for explaining operation of editing electronic data, performed by the information processing system 200 according to this exemplary embodiment of the present invention. The operation of editing electronic data will be described hereinafter with reference to FIG. 8 and FIGS. 9A to 9F.

First, the terminal 2a connects to the electronic device 1 via the network 3 or the near-distance wireless communication network to obtain the electronic data. FIG. 9A illustrates an example of the electronic data. In this exemplary embodiment, the electronic data is facsimile data received by the electronic device 1.

Next, the terminal 2a displays the AR in which a virtual image of the obtained electronic data is superimposed on a medium in a real space, such as a sheet of paper or a notebook, on which a user can handwrite. FIG. 9B illustrates a notebook as an example of such medium. FIG. 9C illustrates the AR display in which the virtual image of the electronic data is superimposed on a left-side page of the notebook which a user wearing the terminal 2a is looking at. A dashed frame line in FIG. 9B indicates a rectangular region corresponding to, for example, an edge of the notebook detected from an image of the notebook. The rectangular region is a region for handwriting, which will be described later, and is used for positioning the image of the electronic data in the AR display illustrated in FIG. 9C.

The user adds the handwriting on the notebook or the sheet of paper, which is being displayed in the AR. FIG. 9D illustrates the AR display immediately after the user added the handwriting of “RECEIVED”. Then, the imaging device 42 of the terminal 2a takes a photo image of the notebook or the sheet of paper on which the user has added the handwriting. Thus, an image of the added handwriting within the dashed frame line is captured, and an image in which the captured image is superimposed on the electronic data is generated to obtain the result of the addition of handwriting.

FIG. 9E illustrates the notebook on which the handwriting has been added. The image in the dashed frame line is imaged and captured. Then, the difference is extracted between the image in the dashed frame line before the addition of handwriting as illustrated in FIG. 9B and the image in the dashed frame line after the addition of handwriting as illustrated in FIG. 9E to obtain the handwritten letters “RECEIVED”. The handwritten letters “RECEIVED” is superimposed on the electronic data in such a manner that they are positioned with each other to obtain the electronic data to which the handwritten letters are added as illustrated in FIG. 9F. The information processing system 200 sends this electronic data to a data transmission source of the original electronic data. With the addition of the letters “RECEIVED”, the data transmission source can confirm that the electronic device 1 has successfully received the facsimile data.

<Software Configuration of Terminal>

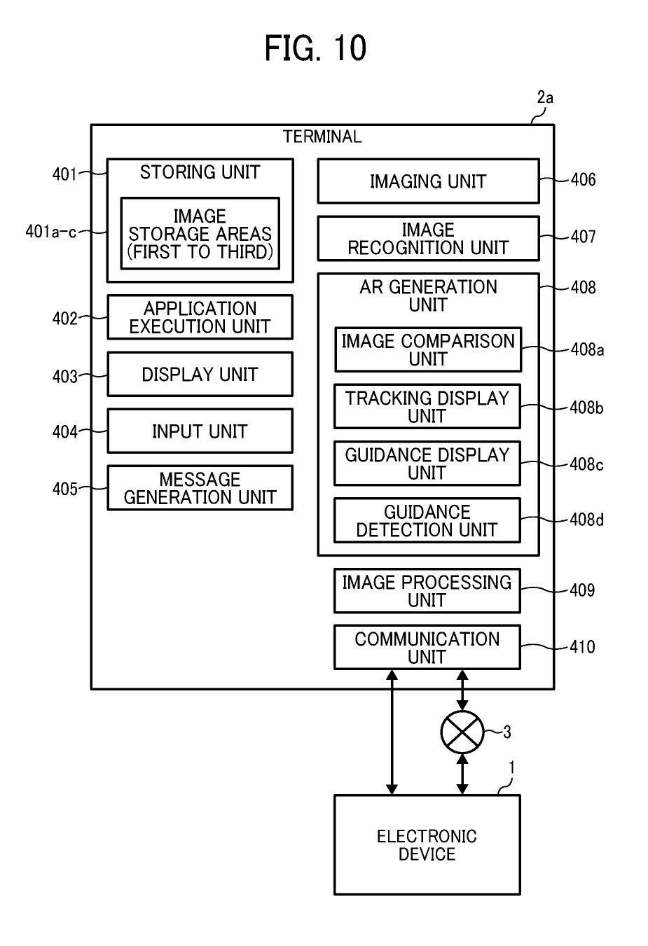

FIG. 10 is a diagram illustrating the software configuration of the terminal 2a in FIG. 8. Because the terminal 2a in FIG. 8 has a same hardware configuration as that of the terminal 2 as illustrated in FIG. 4, explanation of the hardware configuration of the terminal 2a is omitted herein. Further, in explanation of the operation of the terminal 2a in FIG. 8, FIG. 4 will be referred to as to explanation relating the hardware configuration.

As illustrated in FIG. 10, the terminal 2a includes a storing unit 401, an application execution unit 402, a display unit 403, an input unit 404, a message generation unit 405, an imaging unit 406, an image recognition unit 407, an AR generation unit 408, an image processing unit 409, and a communication unit 410.

The storing unit 401 is implemented by the ROM 48, the SSD 50 and the recording medium 52. The storing unit 401 stores electronic data, application software and other various data. Further, the storing unit 401 includes first to third image storage areas 401a to 401c.

The application execution unit 402 activates and executes the application for viewing, editing or storing the electronic data. Examples of the application include a document viewer, an electronic mail viewing application, a facsimile transmission/reception application, an image editing application, and a browser application.

The display unit 403 displays, on the display 43 (FIG. 4), a message, or electronic data such as a file opened (e.g., viewable or editable) by the application execution unit 402. The input unit 404 detects a signal that is input from the input device 41, recognizes the content of the signal, and instructs to execute the function based on the recognized content. For example, the input device 41 allows a user to input an instruction for activating a function menu of the application, selecting a handwriting addition function or a photo taking function from the function menu, etc. The function menu includes editing, storing, printing, adding handwriting and photo taking.

The message generation unit 405 displays a message to the user on the display unit 403. Examples of the message that is generated in response to a message generation request from the application execution unit 402 include “please spread a sheet of paper or open a notebook”, “now saving”, “processing is canceled”, and “please move a sheet of paper or a notebook within a frame line”.

The imaging unit 406 captures an image by the imaging device 42, and sends the captured image to the image storage areas 401a to 401c. The image recognition unit 407 detects a region for handwriting from an image (a first storage image, which will be described later) that is continuously stored in the image storage areas 401a to 401c. The image recognition unit 407 detects the region for the handwriting from, for example, a blank paper, a single color region on paper, or a notebook with ruled lines. The detection of the region is executed using image recognition software by detecting, for example, whether a ratio of an area of a single color is equal to or more than a prescribed value.

The image storage area is provided in a part of the storing unit 401, and includes the first to third image storage areas 401a to 401c. The imaging unit 406 captures images at a predetermined interval, e.g., five times per second while the imaging device 42 is activated. Each image thus captured by the imaging unit 406 at the predetermined interval is referred to as a first storage image. The first image storage area 401a stores the newly captured first storage image while deleting the previously captured storage image, while the imaging device 42 is activated to constantly capture the first storage images. Alternatively, the first image storage area 401a stores the first storage images for a predetermined period of time (a predetermined volume or number) and deletes them therefrom when the predetermined period of time has passed while the imaging device 42 is activated. The image recognition unit 407 recognizes whether the photo image captured by the imaging unit 406 includes the region for handwriting. The second storage area 401b stores the photo image (second storage image), which is recognized as including the region for handwriting by the image recognition unit 40. The third storage area 401c stores the image (third storage image) obtained as a result of the addition of handwriting by the user.

The AR generation unit 408 includes an image comparison unit 408a, a tracking display unit 408b, a guidance display unit 408c, and a guidance detection unit 408d.

The image comparison unit 408 compares the first storage image (image captured continuously) with the second storage image (image including the region for handwriting) to detect a matching region and extract the position information of the matching region. In other words, the image comparison unit 408a functions as a handwriting region detection unit according to some exemplary embodiments of the present invention. The position information is extracted as coordinates indicating where the matching region is present in the first storage image, which corresponds a range of view. For example, a left-bottom corner of the first storage image is indicated by (X, Y)=(0, 0) on coordinates. The coordinates of the positions of corners of the matching region (X, Y)=(A1, A1), (A2, A2), (A3, A3), (A4, A4) are extracted. The first storage image herein is an image obtained by taking the entire view in front of a user or a range that is close to the entire view in front of a user.

In response to detection of the second storage image in the first storage image, the tracking display unit 408b instructs the display unit 403 to display the electronic data on coordinates of the matching region in the range of the view. Further, in the AR display, the region of handwriting is detected with a same aspect ratio as that of the electronic data. The image of the electronic data is displayed in such a manner that the display size thereof is changed to a same size of the region for handwriting.

Furthermore, the tracking display unit 408b detects the inclination and size of the image stored in the second image storage area 401b relative to the image stored in the first image storage area 401a. The tracking display unit 408b deforms the image of the electronic data based on the detection result and displays the deformed image of the electronic data.

With configuration as described so far, the virtual image of the electronic data is displayed in the region for handwriting on a prepared sheet of paper or notebook in such a manner that the virtual image of the electronic data tracks the region for handwriting. Accordingly, the user is able to see the electronic data as if they were printed on the notebook or the sheet of paper, thus making it easier for the user to handwrite the contents that the user wants to add thereon. Moreover, the user is able to add the handwriting at the desired position on the sheet of paper or the notebook without printing out the document.

In such configuration, because the user in fact adds the handwriting behind the AR display (in other words, between the electronic data and the sheet of paper or the notebook), the user cannot easily see his/her hand with it being hidden by the display of the electronic data. Accordingly, a white part in the image of the electronic data displayed in the AR may be converted to a transparent display so that the user can see the space for writing with less difficulty.

In this exemplary embodiment, making use of the known technology of the AR including tracking between a superimposed virtual image and a physical object, it is possible to extract the handwritten information and to overlay the extracted information on the electronic data while preventing the positional displacement therebetween.

The guidance display unit 408c displays the AR for guiding the user to place the region for handwriting on the sheet of paper or the notebook at a predetermined position (e.g., detection position or imaging position). The guidance display unit 408c reads out a position and a shape of the region for handwriting, which is stored in advance when the image of the region for handwriting is taken. The guidance display unit 408c displays a dashed line in accordance with the read-out position and shape. A message, for example, “please place the image (displayed electronic data) within the frame” is also displayed together with the dashed line.

The guidance detection unit 408d detects matching between the guidance display (displayed frame) and the frame of the electronic data. In response to the detection of the matching, the guidance detection unit 408d instructs the imaging unit 406 to take an image of the region for handwriting. With such configuration, the positional displacement between the handwritten contents and the image of the original data is prevented. In other words, the positional displacement is prevented by allowing the imaging unit 406 to take an image of the region for handwriting at a same position as the original imaging position.

The image processing unit 409 compares the second storage image with the third storage image and extracts a difference image based upon the comparison result to obtain an additionally written image. In one example, even in a case where the notebook or the sheet of paper of which image has been taken as the second storage image is not completely blank, e.g., in a case where it includes ruled lines and the like, only the handwritten image is extracted. In a case where the paper on which the handwriting has been added is a blank paper, the handwritten image may be extracted by removing a white region. In another example, if an angle is shifted when taking the image, the image after the addition of handwriting may be corrected. Such correction may be made based upon an angle difference between the paper and the eye glasses. Further, the image processing unit 409 generates an image obtained by superimposing the difference image on the electronic data, and stores the generated image in the storing unit 401. As described above, the image processor 409 functions as a handwritten information extraction unit and a composition unit according to some embodiments of the present invention.

The communication unit 410 is implemented by the communication I/F 46 and the near distance wireless communication device 45. The communication unit 410 communicates data to the electronic device 1, a server device, etc., directly or via the network 3. The electronic data includes a document file, an image, text data or data of a web server for viewing on a browser.

<AR Display and Addition of Handwriting>

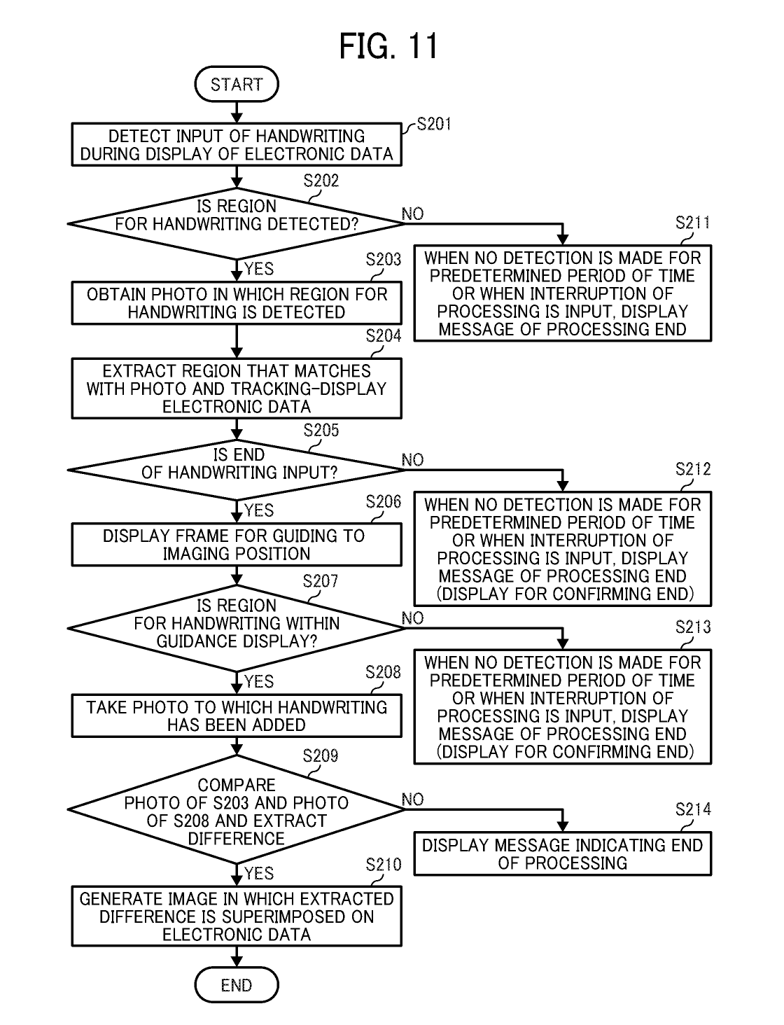

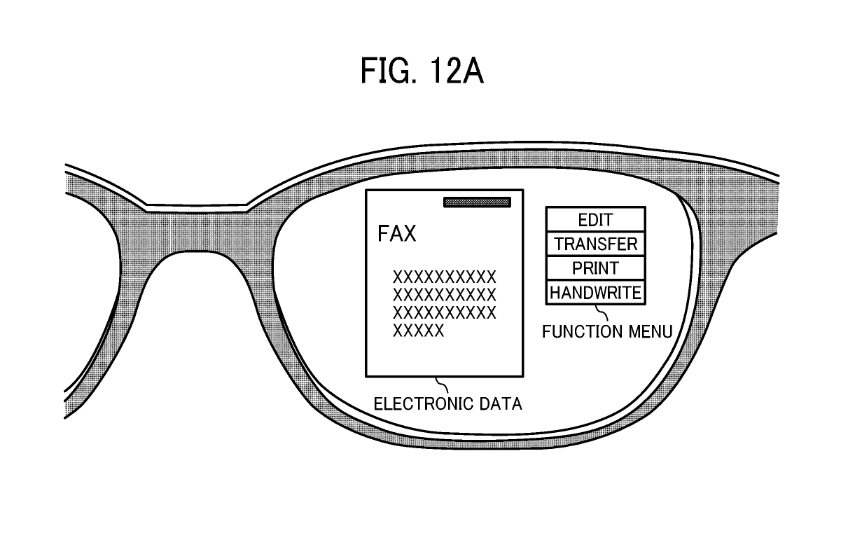

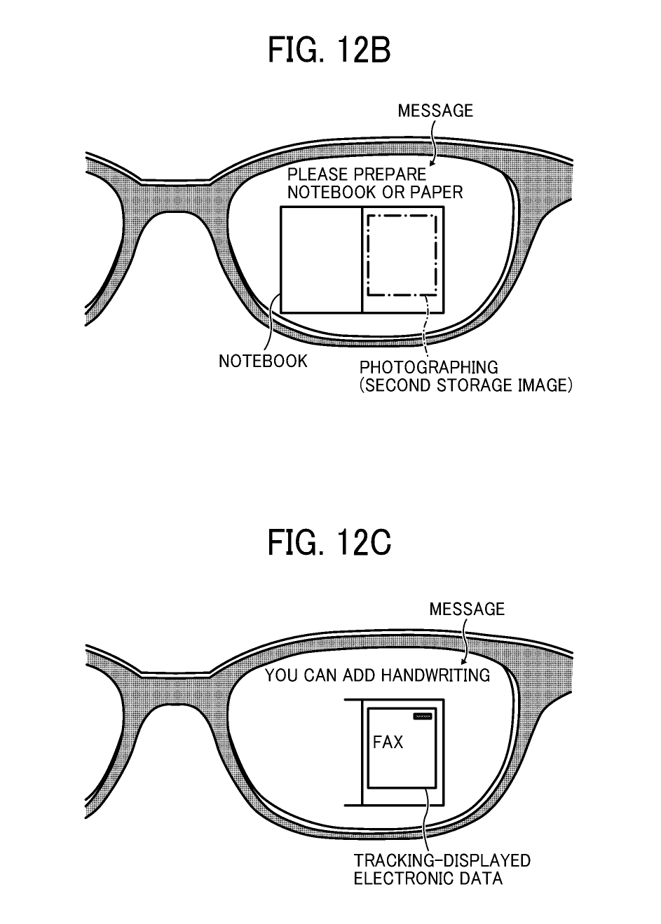

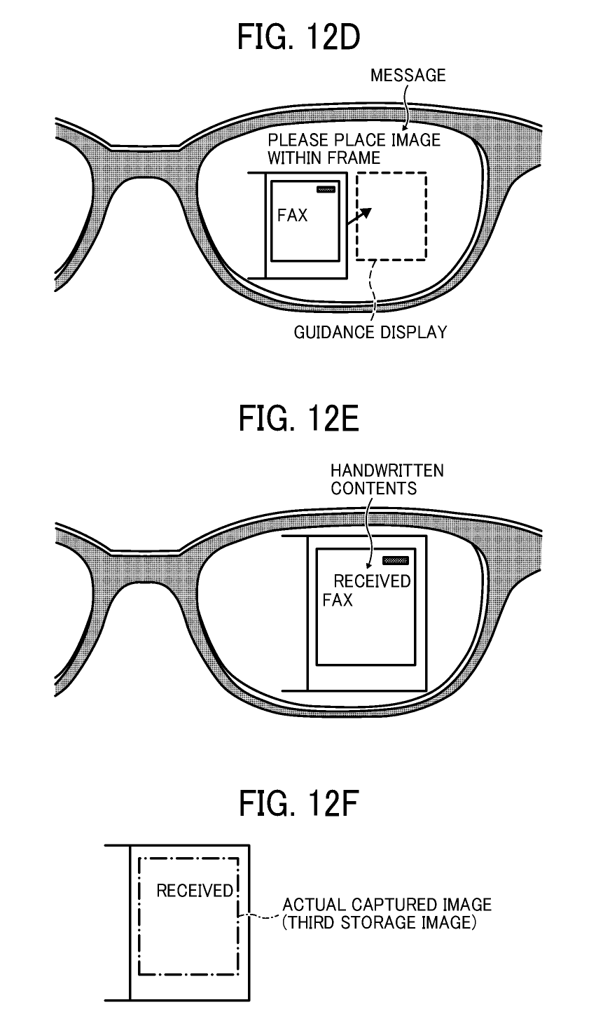

FIG. 11 is a flowchart illustrating the procedure of the AR display and the addition of handwriting performed by the terminal 2a. FIGS. 12A to 12F are diagrams for explaining the procedure illustrated in FIG. 11.

The flowchart of FIG. 11 starts with a state in which the terminal 2a displays on the display unit 403 the electronic data, which the terminal 2a acquires in advance and stores in the storing unit 401.

While the display unit 403 of the terminal 2a displays the electronic data, the user makes an input for starting the addition of handwriting to the displayed electronic data by, for example, voice, touch, or a line of sight. The input unit 404 of the terminal 2a detects the user's input (S201 of FIG. 11, “Handwriting” of “Function Menu” of FIG. 12A). In response to detection of the input, the display unit 403 of the terminal 2a displays a message, for example, “please prepare a notebook or paper”. The user spreads a sheet of paper or open a notebook, for example, on a table, where the user is able to fix a position of the paper or the notebook. In examples as illustrated in FIGS. 12A to 12F, the notebook is used.

A camera, which is an example of the imaging unit 406, of the terminal 2a continuously captures the first storage image while the camera is activated. The image recognition unit 407 detects the region for handwriting from the first storage image (YES at S202). As described earlier, the image recognition unit 407 detects the region for handwriting from a blank paper, a single color region on paper, a notebook with ruled lines, etc.

When the image recognition unit 407 does not detect the region for handwriting for a predetermined period of time (S202: NO), the processing proceeds to S211. When no region for handwriting is detected for a predetermined period of time or when an interruption of processing is input, the display unit 406 displays a message that indicates the end of processing, and the processing ends. The display unit 403 may display a message that inquires the user whether he/she wants to have the terminal 2a continue the detection. In addition, in a case where a white portion of the wall or table is detected in error, the image recognition unit 107 may automatically restart the detection of the region for handwriting in response to a movement such as holding up paper after the erroneous detection.

In a case where the image recognition unit 407 detects the region for handwriting to obtain the second storage image (S202: YES, FIG. 12B), the processing proceeds to S203. At S203, the second image storage area 401b stores the image in which the region for handwriting is detected as the second storage image. In FIG. 12B, the region for handwriting as indicated by a dashed frame line is detected from a right page of the notebook.

Then, the image comparison unit 408 compares the first storage image, which is stored in the first image storage area 401a while the camera is activated, with the second storage image, which includes the region for handwriting, to detect the matching region and extract the position information of the matching region. The tracking display unit 408b instructs the display unit 403 to display the electronic data at a position of the matching region in the range of the view (S204, FIG. 12C).

In this tracking display, the image of the electronic data is changed to the same shape and size as those of the matching region, and the image of the electronic data is displayed in the changed shape and size. Thus, the virtual image of the electronic data is displayed in such a manner that the virtual image of the electronic data tracks the region for handwriting. Accordingly, because the user is able to see the electronic data as if they were printed on the notebook or the sheet of paper, the user is able to add the handwriting at the desired position on paper without printing out the document. FIG. 12C illustrates a state in which the user himself/herself moves, or alternatively the user moves the notebook so that the right page of the notebook is positioned substantially in the center of the user's view, and the virtual image of the electronic data is displayed on the notebook after the movement. In addition, a message “you can add the handwriting” is displayed in FIG. 12C.

At this step, the user in fact adds the handwriting behind the AR tracking display of the electronic data (in other words, between the displayed electronic data and the physical sheet of paper or notebook), the user is likely to have difficulty in seeing his/her hand with it being hidden by the tracking display of the electronic data. In order to prevent such difficulty, a white part in the image of the electronic data, which is displayed in the AR so as to track the movement of the physical object, may be converted to a transparent display. FIG. 12C illustrates a state in which a part near the upper right corner in the left page of the notebook is made visible by such transparent display to allow the user to see the space for handwriting with less difficulty.

When the user finishes adding the handwriting, the user inputs the end of handwriting to the input unit 404 (S205). In response to the input by the user (S205: YES), the processing proceeds to S206. When the input has not been detected for a predetermined period of time or when an interruption of processing is input, the display may be made, which indicates the end of processing or which confirms the user as to whether he/she wants the processing to end (S205: NO; S212).

At S206, the guidance display unit 408 displays the AR (e.g., a frame) that guides the user to place the region for handwriting on the sheet of paper or the notebook at a predetermined position (e.g., detection position or imaging position) as illustrated in FIG. 12D. At this step, the guidance display unit 408 reads out the position coordinates and shape of the region for handwriting, which is stored in advance when the region for the handwriting is detected at S203. The guidance display unit 408c displays the frame in a dashed line and the like at the predetermined position in accordance with the read-out shape. A message, for example, “please place the image within the frame” is also displayed together with the frame. In response to the movement of the notebook within the dashed frame line by the user, to which notebook the user has added the handwriting, the image of the electronic data moves so as to track the region for handwriting. Accordingly, the user is able to align the image of the electronic data with the frame. Such configuration allows the handwriting to be added to the electronic data in accordance with the user's intended position and content.

Next, the guidance detection unit 408d detects a matching between the guidance display (dashed frame line) and the frame of the electronic data (S207: YES) and instructs the imaging unit 406 to take an image of the region for handwriting (S207: YES, S208, FIG. 12E). The third image storage area 401c stores the image taken by the image unit 406 as the third storage image (FIG. 12F).

The guidance display and detection as described above prevent the handwritten content from shifting away from the original position of the image of the electronic data. In other words, the positional displacement is prevented by allowing the imaging unit 406 to take an image of the region for handwriting at a same position as the original imaging position. When the guidance detection unit 407 does not detect the matching between the guidance display and the frame of the image of the electronic data or when an interruption of imaging is input, the display may be made, which indicates the end of processing or which confirms the user as to whether he/she wants the processing to end (S207: NO, S213).

The image processing unit 409 compares the second storage image detected at S203 (the image in which the region for handwriting is detected; the image within a dashed frame line in FIG. 12B) with the third storage image stored at S208 (image to which the handwriting has been added; the image within a dashed frame line in FIG. 12F). In other words, the image processing unit 409 compares the image within the region for handwriting before the addition of handwriting and the image within the region for handwriting after the addition of handwriting to extract the difference therebetween (S209: YES). When the image processing unit 409 does not extract the difference (S209: NO), a message that indicates that the processing ends because no handwriting is added (S214).

Thus, only the image to which the handwriting has been added is obtained. Even in a case where the region for handwriting of the second storage image detected at S203 is not completely blank, e.g., in a case where it includes ruled lines and the like, only the handwritten image is extracted.

In a case where the paper on which the handwriting has been added is a completely blank paper, the handwritten image may be extracted by removing a white region. If an angle is shifted when taking the image, the image after the addition of handwriting may be corrected based upon an angle difference between the paper and the eye glasses.

Then, the image processing unit 409 superimposes the difference image on the electronic data and stores the image obtained by the superimposition in the storing unit 401 (S210). The terminal 2a may automatically, for example, send or print the electronic data on which the difference image has been superimposed in accordance with a way used for obtaining the original electronic data. For example, in a case where the original electronic data are received by facsimile, the electronic data on which the handwritten image has been superimposed is sent back as a reply to the facsimile transmission source. Alternatively, in a case where a user obtains the original electronic data as electronic documents for meeting from other devices, the electronic data on which the handwritten image has been superimposed may be automatically transferred to a PC or a smartphone as the user's own note to save the user's efforts for transmitting the data.

As described so far in detail, the information processing system 200 according to an exemplary embodiment of the present invention has the following features (1) to (6).

(1) The addition of handwriting to electronic data is implemented using the AR display. Specifically, the terminal generates the region for handwriting (displays the AR in which the virtual image of the region for handwriting are overlaid on physical paper). The terminal extracts the information that is handwritten in the region for handwriting and superimposes the extracted information on the electronic data. Accordingly, the handwritten information is added to electronic data such as document data in a simple manner without printing the electronic data and scanning the sheet that is printed out after the addition of handwriting.

(2) The terminal compares the image before the addition of handwriting (second storage image) with the image after the addition of handwriting (third storage image) to extract the handwritten information. Accordingly, the handwritten information is extracted even in a case where the region for handwriting is not blank.

(3) The terminal displays the electronic data in such a manner the virtual image of electronic data tracks the region for handwriting, the user of the terminal is able to virtually add the handwriting on the electronic data in a close state where the electronic data are printed on the user's notebook, etc.

(4) The terminal generates and displays a message to instruct the user of the terminal to, for example, open a notebook or handwrite characters or figures.

(5) The terminal displays a guidance that guides the user to capture the image after the addition of handwriting (third storage image) to enable the user to take an image of the region for handwriting at a predetermined position. Accordingly, the handwritten information is prevented from being superimposed on the electronic data at a shifted position.

(6) The terminal sends the electronic data on which the handwritten information has been superimposed to a device from which the original data has been sent. Accordingly, in a case where, for example, the user wants to add the handwriting on the received data such as a facsimile document, a series of works are performed in a simple manner.

The above-described embodiments are illustrative and do not limit the present invention. Thus, numerous additional modifications and variations are possible in light of the above teachings. Examples of such additional modifications and variations include the following (1) and (2).

(1) An information processing system including a terminal having functions (software configuration) of both of terminal 2 and terminal 2a according to the exemplary embodiments.

(2) A part or some parts of functions of the terminal 2a, such as the image recognition unit 407, the AR generation unit 408 and the image processing unit 409, may be implemented by an external server.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. A transmissive head mounted display, comprising:
an imaging device to acquire an image of a real space, the real space including at least a medium to which a user can physically add handwriting;
a display to display a virtual image of electronic data to the user so as to be superimposed on the medium in the real space using the acquired image of the real space; and
processing circuitry configured to
acquire an image of the real space including at least the medium having the handwringing of the user added,
extract handwritten information from the image of the real space including at least the medium having the handwriting of the user added, and
superimpose the extracted handwritten information on an image of the electronic data.

2. The head mounted display according to claim 1, wherein the processing circuitry is configured to compare the image of the real space including at least the medium having no handwriting of the user, with the image of the real space including at least the medium having the handwriting of the user added to extract the handwritten information.

3. The head mounted display according to claim 1, wherein
the imaging device acquires a first image of the real space having at least no medium, and a second image of the real space having at least the medium, and the processing circuitry compares between the first image and the second image to cause the virtual image of the real space to be superimposed on the medium.

4. The head mounted display according to claim 1, wherein the processing circuitry is configured to generate a message that prompts a user to take an action before acquiring the second image for output to the user, the action including a preparation of the medium.

5. The head mounted display according to claim 1, wherein the processing circuitry is configured to control the display to display a guidance for moving the medium to which the handwriting has been added to a predetermined position.

6. The head mounted display according to claim 1, wherein the processing circuitry is configured to send the image of the electronic data on which the handwritten information has been superimposed to a source device from which original electronic data is sent.

7. The head mounted display according to claim 1, wherein the processing circuitry is configured to acquire, from an external electronic device, a device identification image that identifies the external electronic device and connection information for connecting the head mounted display with the external electronic device, the head mount display further comprising:
a communication interface to connect the head mounted display with the external electronic device through a network, when the device identification image is present in the image acquired by the imaging device.

8. An information processing system, comprising:
the head mounted display of claim 1; and
an electronic device.

9. An information processing method performed by a transmissive head mounted display, comprising:
acquiring an image of a real space, the real space including at least a medium to which a user can physically add handwriting;
displaying a virtual image of electronic data to the user so as to be superimposed on the medium in the real space using the acquired image of the real space;
acquiring an image of the real space including at least the medium having the handwringing of the user added;
extracting handwritten information from the image of the real space including at least the medium having the handwriting of the user added and
superimposing the extracted handwritten information on an image of the electronic data.

10. The information processing method according to claim 9, further comprising:
comparing the image of the real space including at least the medium having no handwriting of the user, with the image of the real space including at least the medium having the handwriting of the user added to extract the handwritten information.

11. The information processing method according to claim 9, further comprising:
acquiring a first image of the real space having at least no medium, and a second image of the real space having at least the medium; and
comparing between the first image and the second image to cause the virtual image of the real space to be superimposed on the medium.

12. The information processing method according to claim 9, further comprising:
generating a message that prompts a user to take an action before acquiring the second image, the action including a preparation of the medium.

13. The information processing method according to claim 9, further comprising:
displaying a guidance for moving the medium to which the handwriting has been added to a predetermined position.

14. The information processing method according to claim 9, further comprising sending the image of the electronic data on which the handwritten information has been superimposed to a source device from which original electronic data is sent.

15. The information processing method according to claim 9, further comprising:
acquiring, from an external electronic device, a device identification image that identifies the external electronic device and connection information for connecting the head mounted display with the external electronic device; and
connecting the head mounted display with the external electronic device, when the device identification image is present in the image acquired by the imaging device.
